(19) United States
(12) Patent Application Publication
(10) Pub. No.: US 2007/0064952 A1
(43) Pub. Date: Mar. 22, 2007

(54) Internet facsimile relay apparatus and method, and storage medium

(76) Inventors: Makoto Takada, Ebina-shi (JP); Takanori Masui, Ebina-shi (JP); Masato Sugii, Kawasaki-shi (JP); Nobumi Kusano, Ebina-shi (JP)

Correspondence Address: GAUTHIER & CONNORS, LLP, 225 FRANKLIN STREET, SUITE 2300, BOSTON, MA, 02110, US

(21) Appl. No.: 11/269,992

(22) Filed: Nov. 9, 2005

(30) Foreign Application Priority Data
Aug. 26, 2005 (JP) JP2005-245375

(51) Int. Cl. H04L 9/00

(52) U.S. Cl. 380/286

(57) ABSTRACT

An Internet facsimile relay unit includes an e-mail receiving section that receives an e-mail including an image and a command to transmit the image as a facsimile to a terminal station, a decryption section that decrypts an e-mail by performing a corresponding decryption processing if the e-mail has been encrypted using a public key cryptosystem, a judgment section that judges security on the basis of the state of the encryption processing on the e-mail or the decryption processing result by the decryption section, and a facsimile transmitting section that transmits as a facsimile to the terminal station at least the image that is included in the e-mail according to the command that is included in the e-mail if the judgment section has judged that security is high and transmits as a facsimile to the terminal station at least a judgment result from the judgment section if it was judged that security is low.

### BACKGROUND

1. Technical Field

The present invention relates to Internet facsimile technology for receiving electronic mail that includes images and performing facsimile transmissions, and more particularly to technology for encrypting electronic mail using a public key cryptosystem.

2. Related Art

Increasing in popularity are Internet facsimile services where facsimile transmissions are performed over the Internet. It is known to provide a technique for introducing a digital signature to improve the security of Internet facsimile communications. In this technique, electronic mail (or e-mail) that includes image data and signature information is received, verification of the signature is performed, and the process is terminated if the verification is unsuccessful. However, in this technique, if the verification is unsuccessful, the facsimile transmission is not performed so that the user at the facsimile destination cannot be informed of the fact that the verification was unsuccessful.

### SUMMARY

An Internet facsimile relay unit of the present invention includes an e-mail receiving section that receives an e-mail including an image and a command to transmit the image as a facsimile to a terminal station, a decryption section that decrypts an e-mail by performing a corresponding decryption processing if the e-mail has been encrypted using a public key cryptosystem, a judgment section that judges security on the basis of the state of the encryption processing on the e-mail or the decryption processing result by the decryption section, and a facsimile transmitting section that transmits as a facsimile to the terminal station at least the image that is included in the e-mail according to the command that is included in the e-mail if the judgment section has judged that security is high and transmits as a facsimile to the terminal station at least a judgment result from the judgment section if it was judged that security is low.

A storage medium of the present invention stores a program of instructions executable by a computer to perform a function including the steps of receiving an e-mail that includes an image and a command for facsimile transmission of the image to a terminal station, decrypting an e-mail by performing a corresponding decryption processing if the e-mail has been encrypted using a public key cryptosystem, judging security on the basis of the state of encryption processing for an e-mail or a decryption processing result from the decrypting step, and transmitting as a facsimile to a terminal station at least an image that is included in an e-mail according to a command that is included in the e-mail if the judging step has judged that security is high or transmitting as a facsimile to a terminal station at least a judgment result in the judging step if it was judged that security is low.

A method of the present invention including the steps of receiving an e-mail that includes an image and a command to transmit the image as a facsimile to a terminal station, decrypting an e-mail by performing a corresponding decryption processing if the e-mail has been encrypted using a public key cryptosystem, judging security on the basis of the state of the encryption processing on the e-mail or a decryption processing result from the decrypting step, and transmitting as a facsimile to a terminal station at least an image that is included in an e-mail according to a command that is included in the e-mail if the judging step has judged that security is high or transmitting as a facsimile to a terminal station at least a judgment result in the judging step if it was judged that security is low.

### BRIEF DESCRIPTION OF THE DRAWINGS

Embodiments of the present invention will be described in detail based on the following figures, wherein:

FIG. 1 is a block diagram showing an example configuration of a relay unit;

FIG. 2 is a schematic diagram illustrating an example of an Internet facsimile relay system;

FIG. 3 is a flowchart illustrating a signature verification procedure that is performed at the relay unit;

FIG. 4 is a schematic diagram illustrating a modification of the relay system; and

FIG. 5 is a flowchart illustrating a procedure for signature verification and decryption in the modification.

### DETAILED DESCRIPTION

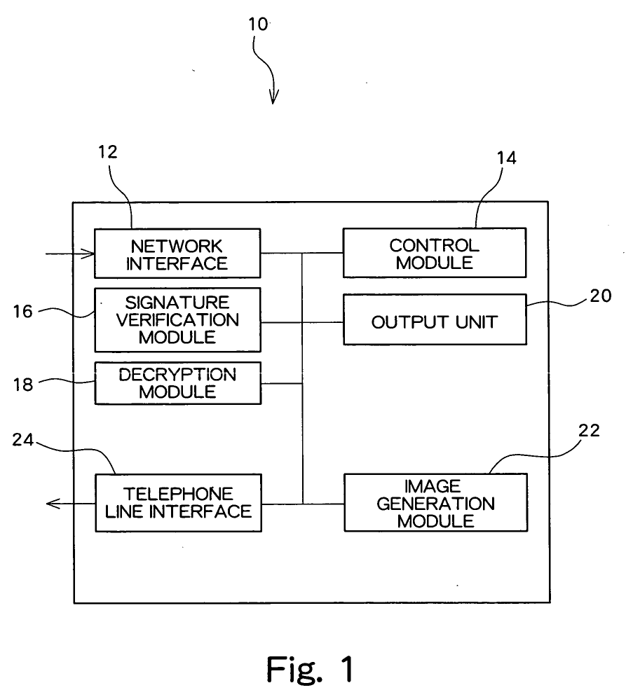

An embodiment will first be described with reference to FIGS. 1 to 3.

FIG. 1 is a block diagram showing an example configuration of a relay unit 10 relating to this embodiment. The relay unit 10 functions as an Internet facsimile relay station and is configured by the installation of a predetermined program in a multifunction machine that has scanner, printer and facsimile functions. As a result, an image attached to an e-mail is received and the image can be transmitted as a facsimile in accordance with an instruction provided by the same e-mail.

The relay unit 10 includes a network interface 12, a control module 14, a signature verification module 16, a decryption module 18, an output unit 20, an image generation module, and a telephone line interface 24.

The network interface 12 performs data communications and can perform the reception of e-mail. The e-mail may be signed with a digital signature or encrypted using a public key cryptosystem. The control module 14 extracts image data (image information), digital signature (signature information), and encryption information that were attached to the received e-mail. The encryption information gives information on the encryption of the e-mail, and more specifically, on the encryption algorithm and key bit length. The signature verification module 16 verifies the validity of the extracted digital signature. When verifying the validity, a public key of the signer becomes necessary. This public key can be obtained as necessary by accessing an external certification authority via the network interface 12 and obtaining a public key certificate. Furthermore, the decryption module 18 performs decryption of the e-mail on the basis of the extracted encryption information. A private key corresponding to the encrypted public key becomes necessary for decryption and this is kept under secret management within the relay unit 10. The output unit 20, such as one configured from a liquid crystal display, performs the display of various processing results and the display of e-mail according to settings.

The image generation module 22 generates an image for a header sheet for a facsimile transmission on the basis of a signature verification result and extracted encryption information. The signature verification result refers to information on the presence or absence of a signature and information on the success (authenticity) or failure (forgery) of the signature verification.

The telephone line interface 24 performs a facsimile transmission to a facsimile destination (also referred to as a terminal station) according to a facsimile transmission command that is included in the e-mail. Namely, the image generated by the image generation module 22 and the image information extracted from the e-mail are transmitted together to the terminal station.

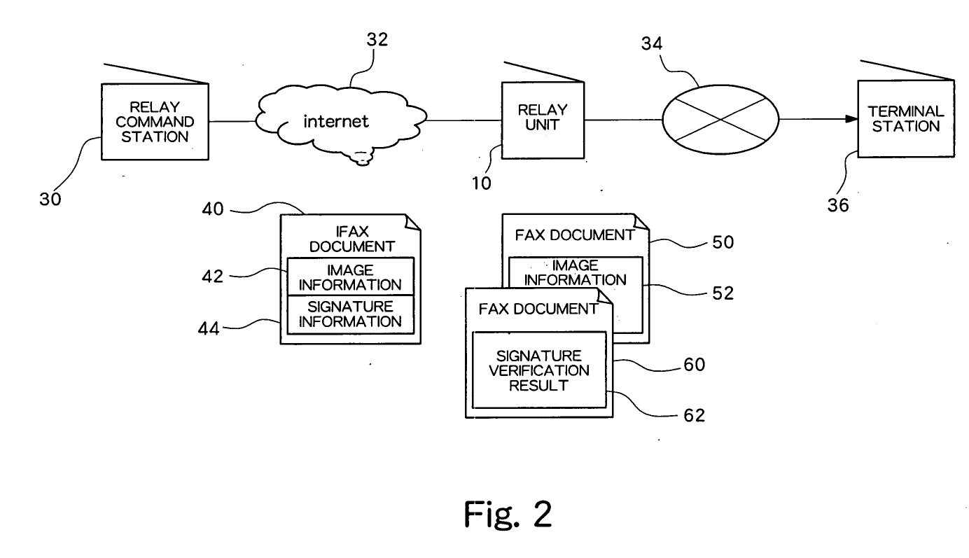

FIG. 2 is a schematic diagram illustrating an Internet facsimile relay system. A relay command station 30 issues Internet facsimile transmission commands and is constructed using hardware, such as a PC or multifunction machine. The relay command station 30 is connected to the relay unit 10 shown in FIG. 1 through an Internet 32. The relay command station 30 stores the private key for signing the digital signature in e-mail and the public key for the relay unit 10 for encrypting the e-mail.

The relay unit 10 is also connected to a telephone line 34 that is used as a facsimile line. A terminal station 36 is connected to the telephone line 34. The terminal station 36 is configured from a facsimile machine or from a multifunction machine having facsimile functions. The terminal station 36 receives facsimile transmissions from the relay unit 10 and forms images onto paper.

The relay command station 30 creates e-mail according to user command. To create e-mail, the user specifies a destination for the e-mail, namely, the relay unit 10, and specifies the final facsimile destination, namely, the terminal station 36. Furthermore, image information to be attached to the e-mail is generated, for example, by scanning a paper document. Moreover, commands for digital signature and encryption are received. In this manner, an IFAX document 40 is generated as e-mail and transmitted from the relay command station 30 to the relay unit 10. The IFAX document 40 is shown in the figure without encryption and with only a digital signature. Thus, image information 42, such as a scanned image, and signature information 44 are attached to the IFAX document 40.

The relay unit 10 receives the IFAX document 40 and generates a document for facsimile transmission. In the example shown in the figure, a FAX document 50 that includes image information 52 is generated on the basis of the image information 42 that is included in the IFAX document 40. Furthermore, the relay unit 10 generates a FAX document 60 as a header sheet (FAX document to be transmitted as a cover sheet) for the FAX document 50. A signature verification result 62, which is image information that was generated on the basis of the result of signature verification by the relay unit 10, is attached to the FAX document 60. The terminal station 36 receives the two FAX documents 50, 60 and outputs them to paper.

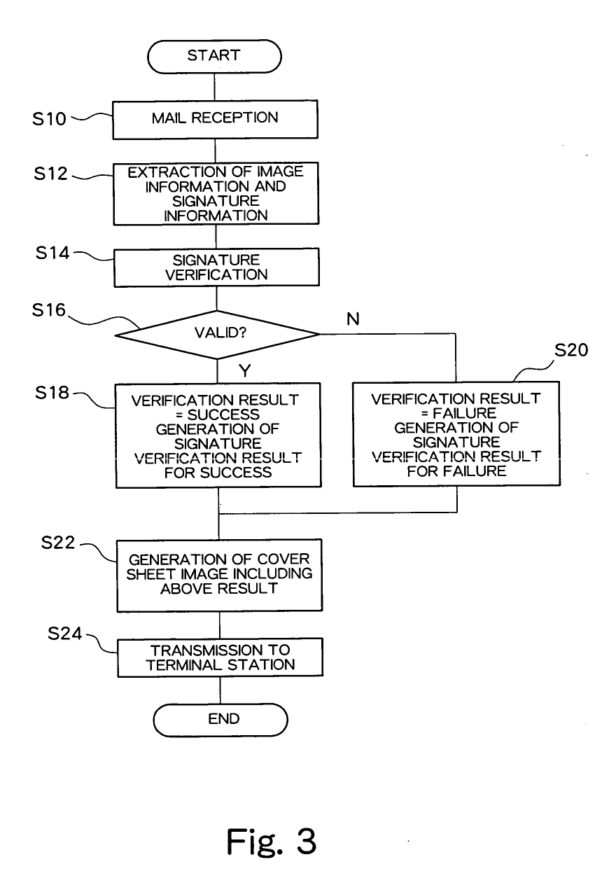

FIG. 3 is a flowchart illustrating the flow of the signature verification procedure in the relay unit 10. The flow of the signature verification procedure in the relay unit 10 will be described hereinafter according to this flowchart with reference to FIGS. 1 and 2. An instance where the relay unit 10 receives the IFAX document 40 is described, namely, where an e-mail that has only been signed with a digital signature and without encryption is received.

At the relay unit 10, when the network interface 12 receives (S10) the IFAX document 40, the control module 14 extracts (S12) the image information 42 and the signature information 44 that are included in the e-mail. The signature verification module 16 verifies (S14) the signature information 44 using a public key certificate of the signer and judges (S16) whether the signature is valid (authentic) or invalid (forged). As a result, if the verification succeeds, namely, if it is judged that the signature is valid, the signature verification result 62 is generated (S18) indicating success. If the verification fails, namely, if it is judged that the signature is invalid, the signature verification result 62 is generated (S20) indicating failure. The image generation module 22 converts the signature verification result 62 into an image and generates a cover sheet image (S22). Then, the FAX document 60 that includes the signature verification result 62 is generated and transmitted as a facsimile (S24) together with the FAX document 50 to the terminal station 36 through the telephone line interface 24. As a result, the state of security at any time can be perceived at the terminal station 36 since information is received regardless of whether the signature verification succeeds or fails.

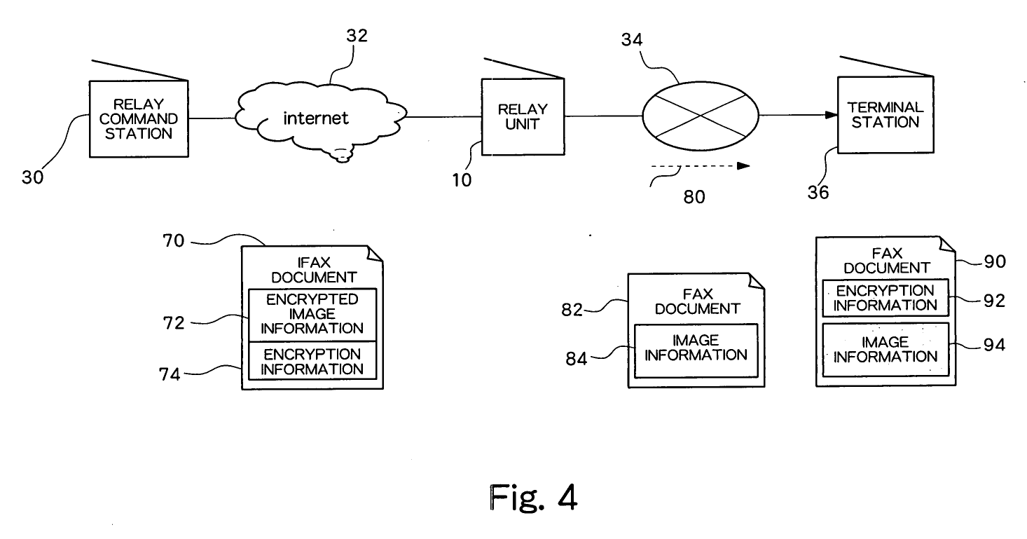

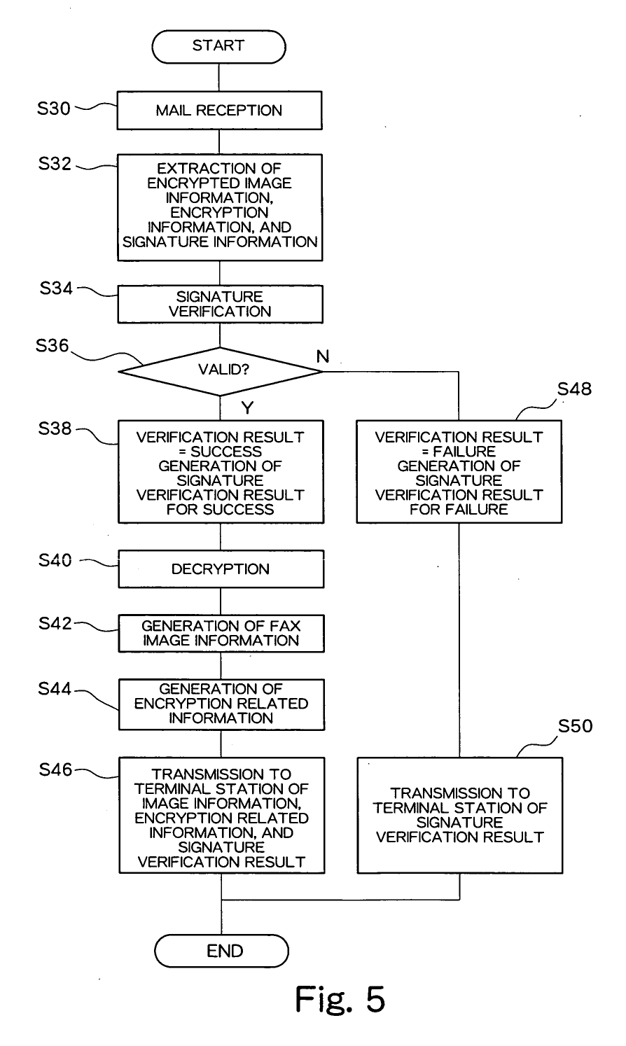

A modification will be described next using FIGS. 4 and 5. FIG. 4 is a schematic diagram illustrating the Internet facsimile relay system. The basic configuration is the same as in FIG. 2 and corresponding parts are designated by like reference numerals and their descriptions will be omitted. In this example, an IFAX document 70 that is transmitted by e-mail by the relay command station 30 includes encrypted image information 72 and encryption information 74. The encrypted image information 72 contains image information, such as of a scanned image, that has been encrypted with a public key for the relay unit 10. Furthermore, the encryption information 74 denotes the encryption algorithm and key bit length. Although signature information is also included in the IFAX document 70 as in the case of FIG. 2, it has been omitted in the figure for the sake of simplicity.

When the IFAX document 70 is received at the relay unit 10, the encrypted image information 72 is decrypted to yield image information 84. This image information 84 is transmitted as a FAX document 82 and during this facsimile transmission encryption information 80 is transmitted as non-image information. At the terminal station 36 receiving the image information 84 and the encryption information 80, an image is generated on the basis of the encryption information 80 and combined with the image information 84. Then, a FAX document 90 that includes both encryption information 92 and image information 94 as image data is created and printed out.

FIG. 5 is a flowchart showing the processing flow for implementing the mode shown in FIG. 4. When e-mail is received (S30) at the relay unit 10, the control module 14 extracts (S32) the encrypted image information 72, the encryption information 74, and the signature information that are included in the e-mail. The signature verification module 16 verifies (S34) the signature information and judges the validity of the signature (S36). As a result, if the signature is judged to be valid, the signature verification result is generated indicating success in the verification (S38). Then, the decryption module 18 decrypts the encrypted image information 72 (S40). Next, the FAX document 82 that includes the image information 84 is generated (S42). Furthermore, encryption related information is generated (S44) on the basis of the encryption information 74. The encryption related information includes encryption information 74, namely, information on the encryption algorithm and key bit length, as well as information on the presence or absence of encryption and information on whether or not decryption was successful. Finally, the facsimile transmission of the FAX document 82 is performed by the telephone line interface 24. In this transmission, the image information 84 is transmitted as image data and the encryption related information and the signature verification result are transmitted as non-image information according to a protocol. Then, at the terminal station 36 that receives the facsimile transmission, the image information and the non-image information are output as one image.

If the signature verification fails in step S36, a signature verification result is generated (S48) indicating failure. In this case, decryption of the encrypted image information is not performed. Thus, the image information is not transmitted and only the signature verification result is transmitted to the terminal station 36. The signature verification result may be transmitted as an image or transmitted as non-image information.

Next, various modifications of the embodiment of the present invention will be described.

In one embodiment of the present invention, the Internet facsimile relay unit transmits (transfers) as a facsimile an image attached to a received e-mail on the basis of an Internet facsimile (also referred to as IFAX) standard (RFC (Request For Comment) 3192) or another official or private standard. The Internet facsimile relay unit can be implemented by controlling hardware, which has arithmetic functions, through software (program). Hardware examples include multifunction machines (machines equipped with at least either a scanner or printer function in addition to the facsimile function) or facsimile machines equipped with an e-mail receiving function, or personal computers (PC) capable of controlling facsimile communications.

An e-mail receiving section receives e-mail that includes an image and a facsimile transmission command. The image is usually formed according to a data format complying with a facsimile protocol. However, even if the image is formed according to another data format, it can be adapted for facsimile transmission by first being converted to an appropriate format at the Internet facsimile relay unit. The image can be included in an e-mail by performing an attachment operation, for example. Furthermore, a facsimile transmission command is executed according to RFC3192 by being specified in the destination mail address field. However, the facsimile transmission command may be executed on the basis of another standard, such as by attaching instructions to the e-mail field, for example.

If encryption processing has been performed according to a public key cryptosystem on an e-mail, a decryption section performs the corresponding decryption processing. The encryption processing according to a public key cryptosystem refers to signing a digital signature using a private key or performing encryption using a public key. Both digital signature and encryption may also be applied. Furthermore, the decryption processing corresponds to the encryption processing and refers to performing signature verification using the public key that corresponds to the private key or performing decryption using the private key that corresponds to the public key. Additional processing can be performed during encryption and decryption to generate a message digest using a secure hash function.

A judgment section judges security on the basis of the state of the encryption processing for an e-mail or a decryption processing result from the decryption section. The state of the encryption processing can be judged from the presence or absence of encryption processing, encryption strength (which can be judged from the encryption algorithm and key bit length), and so forth. The security can generally be considered to be low if encryption processing has not been performed or if the decryption processing result is unsatisfactory. The judgment section judges the security according to a standard that was set from this viewpoint.

A facsimile transmitting section performs a facsimile transmission to a terminal station. The facsimile transmission refers to the transmission of image and non-image information using a facsimile line and performed according to a facsimile protocol. If the judgment section judges that security is high, at least an image that is included in an e-mail is transmitted according to instruction that is included in the e-mail, and if security is judged to be low, at least a judgment result (either as an image or non-image information) is transmitted. In addition to the judgment result, the reason behind the judgment can also be transmitted. If security is judged to be high, the judgment result may also be transmitted, and if security is judged to be low, an image that is included in an e-mail can also be transmitted in whole or in part.

According to this mode, if it is judged that security in Internet facsimile is low as a result of the security verification by the decryption processing, the judgment result is transmitted as a facsimile to the terminal station. As a result, the terminal station user can perceive that secure Internet facsimile cannot be ensured. It then becomes possible to promptly deal with such problems as security leaks and forgery.

In one mode of the Internet facsimile relay unit of the present invention, the encryption processing is the digital signature that is signed with a private key of the originator of the e-mail, the decryption processing is the verification of the digital signature that is performed with a public key corresponding to the private key, and the judgment section judges security on the basis of the state of the digital signature or the result of the digital signature verification. Generally, if there is no digital signature, the security is said to be low, or if the digital signature is judged from the verification process to have been forged, the security can be said to be considerably low. The judgment section judges security according to a standard that was set from this viewpoint.

In one mode of the Internet facsimile relay unit of the present invention, the encryption processing is the encryption that is performed with a public key of the Internet facsimile relay unit, the decryption processing is the decryption that is performed with a private key corresponding to the public key, and the judgment section judges security on the basis of the state of the encryption or the decryption result. Generally, if there is no encryption, the security is said to be low, and if there is a problem where encryption was performed but decryption could not be performed, the security can be said to be considerably low. The judgment section judges the security according to a standard that was set from this viewpoint.

In one mode of the Internet facsimile relay unit of the present invention, the facsimile transmission of the judgment result in the facsimile transmitting section is performed by generating an image indicating the judgment result and transmitting the image as a facsimile to the terminal station. The image may be formed by combining it with an image that is included in an e-mail or may be formed separately. Furthermore, in one mode of the Internet facsimile relay unit of the present invention, the image indicating the judgment result is generated by superimposing the judgment result on the image that is included in the e-mail and the facsimile transmission of the judgment result in the facsimile transmitting section simultaneously transmits as a facsimile the image that is included in the e-mail and the judgment result to the terminal station by transmitting the image indicating the judgment result as a facsimile.

In one mode of the Internet facsimile relay unit of the present invention, in the facsimile transmission of the judgment result in the facsimile transmitting section, an image that is included in an e-mail and a judgment result are simultaneously transmitted as a facsimile by integrating the judgment result as non-image information according to facsimile protocol into the facsimile transmission of the image that is included in the e-mail. For example, when transmitting an image as a facsimile, non-image information can be integrated into the transmission header.

In one mode of the Internet facsimile relay unit of the present invention, the facsimile transmitting section does not perform the facsimile transmission of an image that is attached to an e-mail in whole or in part if it is judged that security is low. If security is low, it is not necessarily required to transmit all the images. For example, if there is a risk of the attached image being forged, transmitting part of the image as a facsimile is sufficient, and if there is a risk of the facsimile number of the terminal station being forged, it may be better not to transmit the image at all. Also, for example, if the decryption of an image fails, it becomes unnecessary to transmit the image.

In one mode of the Internet facsimile relay unit of the present invention, if it is at least judged that security is low, the facsimile transmitting section performs a facsimile transmission to the terminal station of information on the originator of an e-mail or information on the implementation of encryption processing using a public key cryptosystem on the e-mail in addition to the judgment result. The information on the originator of the e-mail includes information on the sender, transmitting station, and transmission path. This information may be provided, for example, from the originator mail address, message ID or received path information (information in the Received From field) recorded in the mail header. Furthermore, the information on the implementation of the encryption processing using a public key cryptosystem on e-mail can be illustrated by information on the encryption algorithm or the key bit length in the public key cryptosystem.

A facsimile receiving unit of the present invention is configured from the terminal station to which a facsimile transmission is performed from the Internet facsimile relay unit and is equipped with an output section where non-image information that was sent by facsimile is converted into an image and output. The facsimile receiver can be implemented by controlling hardware, which has arithmetic functions, through software (program). Besides facsimile machines, other examples of such hardware include printers (including multifunction machines) equipped with a facsimile receiving function. The output operation can be performed by simultaneously superimposing the non-image information onto an image that is received or outputting the non-image information on a separate sheet of paper without superimposition.

The entire disclosure of Japanese Patent Application No. 2005-245375 filed on Aug. 26, 2005 including the specification, claims, drawings, and abstract is incorporated herein by reference.

What is claimed is:

1. An Internet facsimile relay unit comprising:
an e-mail receiving section that receives an e-mail including an image and a command to transmit the image as a facsimile to a terminal station;
a decryption section that decrypts the e-mail by performing a corresponding decryption processing if the e-mail has been encrypted using a public key cryptosystem;
a judgment section that judges security on the basis of the state of the encryption processing on the e-mail or the decryption processing result by the decryption section; and
a facsimile transmitting section that transmits as a facsimile to the terminal station at least the image that is included in the e-mail according to the command that is included in the e-mail if the judgment section has judged that security is high, and transmits as a facsimile to the terminal station at least a judgment result from the judgment section if it was judged that security is low.

2. An Internet facsimile relay unit according to claim 1, wherein:
the encryption processing is a signing of a digital signature with a private key of an originator of the e-mail;
the decryption processing is a verification of the digital signature with a public key corresponding to the private key; and
the judgment section judges the security on the basis of a state of the digital signature or a verification result of the digital signature.

3. An Internet facsimile relay unit according to claim 1, wherein:
the encryption processing is an encryption that is performed with a public key of the Internet facsimile relay unit;
the decryption processing is a decryption that is performed with a private key corresponding to the public key; and
the judgment section judges the security on the basis of a state of the encryption or a decryption result.

4. An Internet facsimile relay unit according to claim 1, wherein:
the facsimile transmission of the judgment result in the facsimile transmitting section is performed by generating an image indicating the judgment result and transmitting the image as a facsimile to the terminal station.

5. An Internet facsimile relay unit according to claim 4, wherein:
the image indicating the judgment result is generated by superimposing the judgment result onto the image that is included in the e-mail; and
the facsimile transmission of the judgment result in the facsimile transmitting section simultaneously transmits as a facsimile to the terminal station the image that is included in the e-mail and the judgment result by transmitting the image indicating the judgment result as a facsimile.

6. An Internet facsimile relay unit according to claim 1, wherein:
in the facsimile transmission of a judgment result in the facsimile transmitting section, the image that is included in the e-mail and the judgment result are simultaneously transmitted as a facsimile by integrating the judgment result as non-image information according to facsimile protocol into the facsimile transmission of the image that is included in the e-mail.

7. An Internet facsimile relay unit according to claim 1, wherein:
the facsimile transmitting section does not perform a facsimile transmission, in whole or in part, of the image that was attached to the e-mail if it was judged that security is low.

8. An Internet facsimile relay unit according to claim 1, wherein:
the facsimile transmitting section transmits, as a facsimile to the terminal station, information on an originator of the e-mail or information on implementation of the encryption processing using a public key cryptosystem on the e-mail in addition to a judgment result if it was at least judged that security is low.

9. An Internet facsimile relay unit according to claim 1, wherein:
the command for performing facsimile transmission that is included in the e-mail is specified in a destination mail address field on the basis of the RFC3192 standard.

10. A storage medium readable by computer, the storage medium storing a program of instructions executable by a computer to perform a function comprising the steps of:
receiving an e-mail that includes an image and a command for facsimile transmission of the image to a terminal station;
decrypting the e-mail by performing a corresponding decryption processing if the e-mail has been encrypted using a public key cryptosystem;
judging security on the basis of the state of encryption processing for an e-mail or a decryption processing result from the decrypting step; and
transmitting as a facsimile to a terminal station at least an image that is included in an e-mail according to a command that is included in the e-mail if the judging step has judged that security is high, and transmitting as a facsimile to a terminal station at least a judgment result in the judging step if it was judged that security is low.

11. A storage medium according to claim 10, wherein:
the facsimile transmission of the judgment result in the facsimile transmitting step is performed by generating an image indicating the judgment result and transmitting the image as a facsimile to the terminal station.

12. A storage medium according to claim 10, wherein:
in the facsimile transmission of a judgment result in the facsimile transmitting step, the image that is included in the e-mail and the judgment result are simultaneously transmitted as a facsimile by integrating the judgment result as non-image information according to facsimile protocol into the facsimile transmission of the image that is included in the e-mail.

13. A storage medium according to claim 10, wherein:
a facsimile transmission, in whole or in part, of the image that was attached to the e-mail is not performed in the facsimile transmitting step if it was judged that security is low.

14. A storage medium according to claim 10, wherein:
information on an originator of the e-mail or information on implementation of the encryption processing using a public key cryptosystem on the e-mail is transmitted as a facsimile to the terminal station in addition to a judgment result in the facsimile transmitting step if it was at least judged that security is low.

15. A method comprising the steps of:
receiving an e-mail that includes an image and a command to transmit the image as a facsimile to a terminal station;
decrypting the e-mail by performing a corresponding decryption processing if the e-mail has been encrypted using a public key cryptosystem;
judging security on the basis of the state of the encryption processing on the e-mail or a decryption processing result from the decrypting step; and
transmitting as a facsimile to a terminal station at least an image that is included in an e-mail according to a command that is included in the e-mail if the judging step has judged that security is high, and transmitting as a facsimile to a terminal station at least a judgment result in the judging step if it was judged that security is low.

16. A method according to claim 16, wherein:
the facsimile transmission of the judgment result in the facsimile transmitting step is performed by generating an image indicating the judgment result and transmitting the image as a facsimile to the terminal station.

17. A method according to claim 16, wherein:
a facsimile transmission, in whole or in part, of the image that was attached to the e-mail is not performed in the facsimile transmitting step if it was judged that security is low.

18. A method according to claim 16, wherein:
information on an originator of the e-mail or information on implementation of the encryption processing using a public key cryptosystem on the e-mail is transmitted as a facsimile to the terminal station in addition to a judgment result in the facsimile transmitting step if it was at least judged that security is low.

19. An Internet facsimile relay unit comprising:
an e-mail receiving section that receives an e-mail including an image and a command to transmit the image as a facsimile to a terminal station;
a decryption section that decrypts the e-mail by performing a corresponding decryption processing if the e-mail has been encrypted using a public key cryptosystem;
a judgment section that judges security on the basis of the state of the encryption processing on the e-mail or the decryption processing result by the decryption section; and
a facsimile transmitting section that transmits as a facsimile to the terminal station at least the image that is included in the e-mail according to the command that is included in the e-mail if the judgment section has judged that security meet a predetermined standard, and transmits as a facsimile to the terminal station at least a judgment result from the judgment section if it was judged that security do not meet the predetermined standard.
